(19) United States
(12) Patent Application Publication
(10) Pub. No.: US 2008/0109535 A1
(43) Pub. Date: May 8, 2008

(54) POINT OF SALE DEVICE CONFIGURATION SYSTEMS AND METHODS

(75) Inventor: Malcolm McCue, Glenwood, IA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/556,972

(22) Filed: Nov. 6, 2006

(51) Int. Cl. G06F 15/177

(52) U.S. Cl. 709/220

(57) ABSTRACT

A system for configuring a point-of-sale (POS) device includes a server computer programmed to interactively collect POS device configuration information from a remotely-located user computer and cause the POS device configuration information to be stored as a POS device configuration file. The server computer is programmed to interactively collect the POS device configuration information from the user computer by rendering one or more display screens on the user computer, each of the one or more display screen being configured to collect at least a portion of the POS device configuration information. The system also includes a storage medium configured to store the POS device configuration file and an interface to the POS device. The interface is configured to transmit the POS device configuration file from the storage medium to the remotely-located POS device to thereby configure the POS device.

Embodiments of the invention relate generally to programming electronic devices. Embodiments of the present invention relate more specifically to systems and methods for configuring point-of-sale terminals.

### BACKGROUND OF THE INVENTION

Almost every merchant location is now equipped with a point-of-sale (POS) device configured to accept various types of presentation instruments (e.g., credit cards, debit cards, stored value cards, and the like). POS devices are produced by a variety of manufactures and include a variety of features that are desirable to different merchants for different reasons. Moreover, merchants have different names and addresses, accept different types of presentation instruments, include different information on receipts, and the like, all of which may be programmed into a POS device. Hence, POS devices are generally programmed individually for every merchant.

POS devices typically are placed into operation at a merchant's location by a representative of a financial institution (e.g., bank) or “Independent Sales Organization” (ISO). It is difficult, however, for these representatives to maintain an inventory of POS devices and the appropriate programming equipment to satisfy every merchant's desire. Improved POS device configuration systems and methods are therefore needed.

### BRIEF SUMMARY OF THE INVENTION

Embodiments of the invention provide a system for configuring a point-of-sale (POS) device. The system includes a server computer programmed to interactively collect POS device configuration information from a remotely-located user computer and cause the POS device configuration information to be stored as a POS device configuration file. The server computer is programmed to interactively collect the POS device configuration information from the user computer by rendering one or more display screens on the user computer, each of the one or more display screen being configured to collect at least a portion of the POS device configuration information. The system also includes a storage medium configured to store the POS device configuration file and an interface to the POS device. The interface is configured to transmit the POS device configuration file from the storage medium to the remotely-located POS device to thereby configure the POS device.

In some embodiments the first network is the Internet and the second network is a Public Switched Telephone Network. The POS device configuration file may be uniquely related to the POS device. A first portion of the POS device configuration information collected by a first display screen may determine a second portion of the POS device configuration information collected by a second display screen. At least one of the one or more display screens may include a plurality of data collection fields configured to collect the POS device configuration information, wherein POS device configuration information collected by a first data collection field is determinative of selection options of POS device configuration information collected by a second data collection field. The selection options may include pick lists, drop down menus, and/or the like. A data collection field associated with a first display screen may include a selection mechanism to notify a POS deployment center to ship the POS device to a particular location.

Other embodiments provide a system for configuring a point-of-sale (POS) device. The system includes a server computer programmed to receive data from a remotely-located user computer. The data includes POS device configuration information and the server computer is further configured to cause the POS device configuration information to be stored as a POS device configuration file. The system also includes a storage medium configured to store the POS device configuration file and an interface to the POS device. The interface is configured to transmit the POS device configuration file from the storage medium to the remotely-located POS device to thereby configure the POS device. In some embodiments the data are be part of an XML file. The first network may be the Internet and the second network may be a Public Switched Telephone Network.

In still other embodiments, a method of configuring a point-of-sale (POS) device includes, at a host computer system, receiving a file creation request from a remotely-located user computer to create a POS device configuration file. The method also includes, in response to the file creation request, rendering one or more display screens on a display of the user computer. The display screens are programmed to interactively collect POS device configuration information from the remotely-located user computer. The method also includes storing the POS device configuration information as a POS device configuration file, transmitting a download identifier related to the POS device configuration file to the remotely-located user computer, and thereafter, receiving a configuration request at the host computer system from the POS device. The configuration request includes the download identifier. The method also includes, in response to the configuration request, sending the POD device configuration file to thereby program the POS device.

In some embodiments, receiving the file creation request includes receiving the file creation request via the Internet. Receiving the configuration request may include receiving the configuration request via a Public Switched Telephone Network. The POS device configuration file may be uniquely related to the POS device. Rendering one or more display screens on a display of the user computer may include rendering a first display screen on the display of the user, receiving a first portion of the POS device configuration information via the first display screen, and using the first portion of the POS device configuration information to determine a second portion of the POS device configuration information collected by a second display screen. At least one of the one or more display screens may include a plurality of data collection fields configured to collect the POS device configuration information. The method may include using POS device configuration information collected by a first data collection field to determine selection options of POS device configuration information collected by a second data collection field. The selection options may include pick lists, drop down menus, and/or the like. A data collection field associated with a first display screen may include a selection mechanism to notify a POS deployment center to ship the POS device to a particular location. The method may include receiving a selection via the selection mechanism to notify the POS deployment center, notifying the POS deployment center in response to receiving the selection, and shipping the POS from the POS deployment center.

In yet other embodiments, a method of configuring a point-of-sale (POS) device includes, at a host computer system, receiving a file creation request from a remotely-located user computer to create a POS device configuration file. The file creation request includes POS device configuration information. The method also includes storing the POS device configuration information as a POS device configuration file, transmitting a download identifier related to the POS device configuration file to the remotely-located user computer, and thereafter, receiving a configuration request at the host computer system from the POS device. The configuration request includes the download identifier. The method also includes, in response to the configuration request, sending the POS device configuration file to thereby program the POS device. The POS device configuration file may be an XML file.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an exemplary point-of-sale device configuration system according to embodiments of the invention.

FIG. 2 illustrates an exemplary point-of-sale device configuration method according to embodiment of the invention, which method may be implemented in the system of FIG. 1.

FIGS. 3A-3K illustrate exemplary display screens that may be used to create a point-of-sale device configuration file according to embodiments of the invention.

### DETAILED DESCRIPTION OF THE INVENTION

Embodiments of the present invention relate to systems and methods for programming electronic devices. In order to provide a context for describing embodiments of the present invention, embodiments of the invention will be described herein with reference to programming a point-of-sale (POS) device to accept various types of presentation instruments (e.g., credit cards, debit cards, stored value cards, gift cards, etc.). Those skilled in the art will appreciate, however, that other embodiments are possible. For example, embodiments of the invention may be used to program cash registers or other types of POS devices.

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It is to be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems may be shown in block diagrams in order not to obscure the embodiments in unnecessary detail. In other instances, well-known processes, structures and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

According to embodiments of the present invention, a POS device is programmed by first creating a POS device configuration file. The file is created by a user accessing a web site and entering POS device configuration information into one or more display screens programmed to collect the information. The configuration information is saved on a server as a POS device configuration file, and a download identifier is sent to the user. Thereafter, the user installs the POS device and enters the download identifier into it. The POS device transmits the download identifier to the server and receives the configure file in response, thereby configuring the POS device.

The user may be a representative of, for example, a financial institution or “Independent Sales Organization” (ISO) that supplies may different types of POS devices to may different merchants. Embodiments of the invention provide the advantage that the user is not required to stock an inventory of POS devices and associated programming equipment. The user is able to instantly create a configuration file for a specific POS to be installed at a specific merchant location, instruct the POS device to be shipped to a specific location (either to the user or directly to the merchant), and thereafter configure the POS device by simply entering the download identifier into the POS device and interfacing the POS device to a network.

In some embodiments, the user may create the configuration file using the web interface, and the POS may be configured prior to shipment from a POS device deployment center. In other embodiments, the user completes the configuration as described above.

In some embodiments the display screens of the web interface are interdependent. That is, the configuration information collected by one display screen is determined by a previous display screen. For example, one display screen may be used to collect configuration information that identifies the manufacturer of the POS device to be configured. A subsequent display screen may then collect configuration information related to the model of the POS device to be programmed, and the display screen may include a list of models, which list is limited to the particular manufacturer identified in response to the prior display screen. Many such examples are possible.

In some embodiments, the display screens include interdependent data collection fields. That is, configuration information entered onto a first data collection field may determine selection options that are available for receiving configuration information in a second data collection field. The selection options may include, for example, pick lists, drop down menus, and/or the like. For example, a first data collection field may include a option for configuring the POS device to accept debit cards. Because personal identification numbers (PIN) are generally required to complete debit card transactions, a second data collection field may be enabled, which data collection field includes a drop down menu of options that represent various types of PIN pad entry types. The user then selects the PIN pad entry device that corresponds to the one to be configured on the POS device. Many such examples are possible.

In some embodiments, a host computer system is configured to receive from a user a file that includes all the configuration information necessary to configure the POS device. The file may be, for example, an XML file. The XML file may then be converted into a POS device configuration file and stored for later download as in other embodiments.

In some embodiments, a data collection field or an entry in a configuration file may include an indicator that requests that the POS device to be configured be mailed from a POS deployment center.

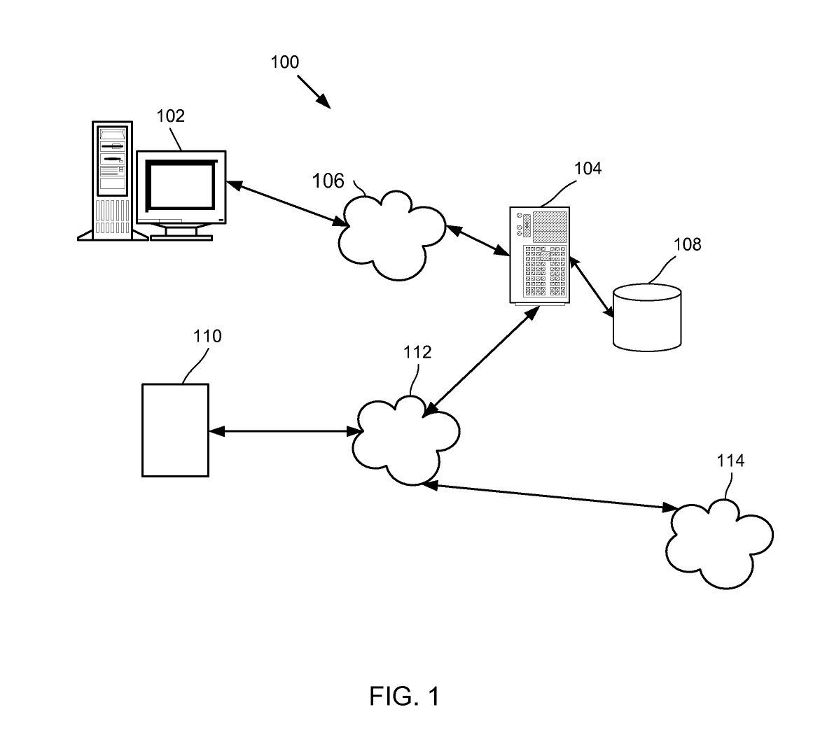

Having described embodiments of the present invention generally, attention is directed to FIG. 1, which illustrates an exemplary POS configuration system 100 according to embodiments of the invention. Those skilled in the art will appreciate that the system 100 is merely exemplary of a number of possibly systems according to embodiments of the invention. The system 100 includes a user computer 102, a server computer 104, and a network 106 through which the two communicate. The user computer 102 may be any of a variety of computing devices know to those skilled in the art, including, for example, a desktop computer, a laptop computer, and the like. The user computer includes a display screen and application software that programs the user computer to communicate with other computers. In this embodiment, the user computer 102 also includes web browser software. In some embodiments, however, the user computer 102 may include software that programs it to compile POS device configuration information into a file (e.g., XML file) for transmission to the server computer 104.

The server computer (AKA, host computer) 104 may be any of a variety of computing devices known to those skilled in the art, including, for example, a web server, a mainframe, a workstation, or the like. In this embodiment, the server computer 104 includes application software that programs it to host a web site through which the server computer 104 collects POS device configuration information. The server computer 104 has a storage device 108 associated with it, which storage device 108 may be any of a variety of well know data storage devices. The storage device 108 may be integral to the server computer 104 or the two may be distinct devices.

In this embodiment, the network 106 is the Internet. In other embodiments, the network 106 may be any of a variety of well known networks and may include wired and wireless links.

The user computer 102 is located remotely from the server computer 104. In a specific embodiment, the user computer 102 is a laptop computer that a sales representative (AKA, “rep”) of an ISO or financial institution may use to configure a POS device 110 that the rep intends to install at a merchant location. The rep uses the user computer 102 to access a web site hosted by the server computer 104 and interactively provides POS device configuration information specific to the POS 110 the rep intends to install. The POS device configuration information is then saved as a POS device configuration file on the storage device 108. The user is provided with a download identifier that may be used thereafter to access the POS device configuration file.

Continuing with a description of this embodiment, the POS device 110 thereafter may be configured at any of a number of locations. In some embodiments, a sales rep maintains a sufficient inventory of POS devices that the rep may select a satisfactory POS device from his inventory and continue with configuring the device. In other embodiments, a sales rep may request, possibly as part of the POS device configuration file creation process, that a satisfactory POS device be shipped from a POS device deployment center to either the sales rep or directly to the merchant. The deployment center may access the configuration file and configure the device prior to shipment, or the deployment center may ship the device prior to configuration.

In any of the previously-mentioned embodiments, the POS device 110 may be configured by interfacing it to the server computer 104 via a second network 112. In some embodiments the second network 112 is the Internet. In other embodiments the second network 112 is a Public Switched Telephone Network (PSTN) or other suitable network. In a specific embodiment, the rep installs the POS device 110 at the merchant location, interfaces the POS device 110 to the server computer 104 via a PSTN, and enters the download identifier into the POS device 110, thereby initiating a POS device configuration process. Thereafter, the POS device 110 may be used to process presentation instrument transactions by sending transaction information to a transaction processing network 114, possibly via the second network 112.

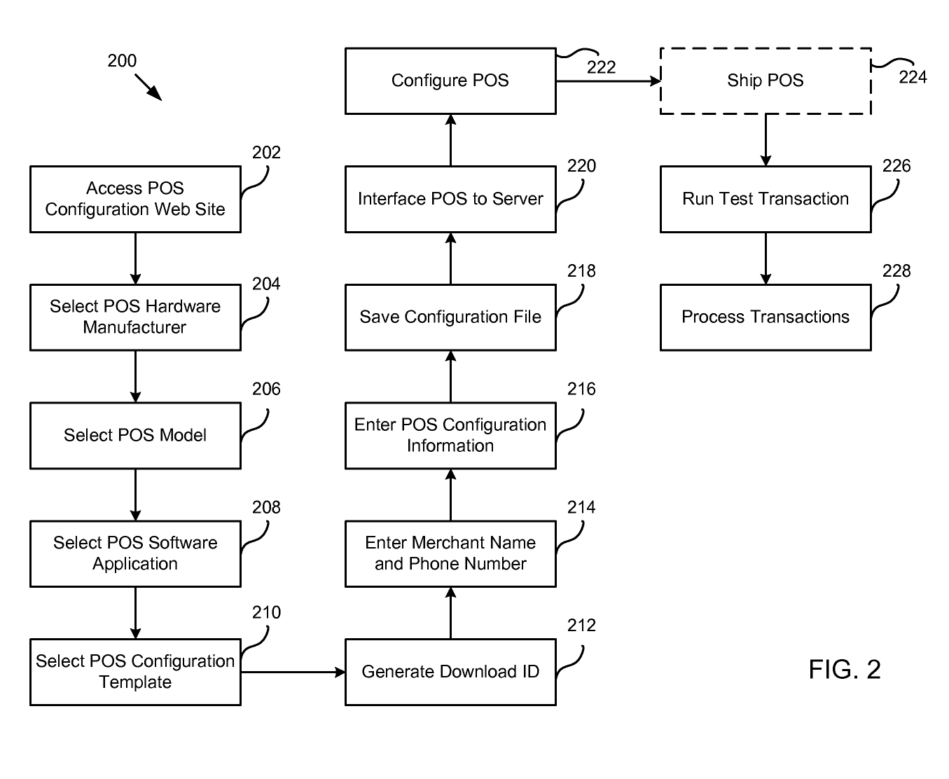

Having described an exemplary system 100 according to embodiments of the invention, attention is directed to FIG. 2, which illustrates an exemplary method 200 according to embodiments of the invention, which method may be implemented in the system of FIG. 1. Those skilled in the art will appreciate that the method 200 is merely exemplary of a number of possible methods according to embodiments of the invention. Other exemplary methods according to other embodiments may include more, fewer, or different steps than those illustrated and described herein.

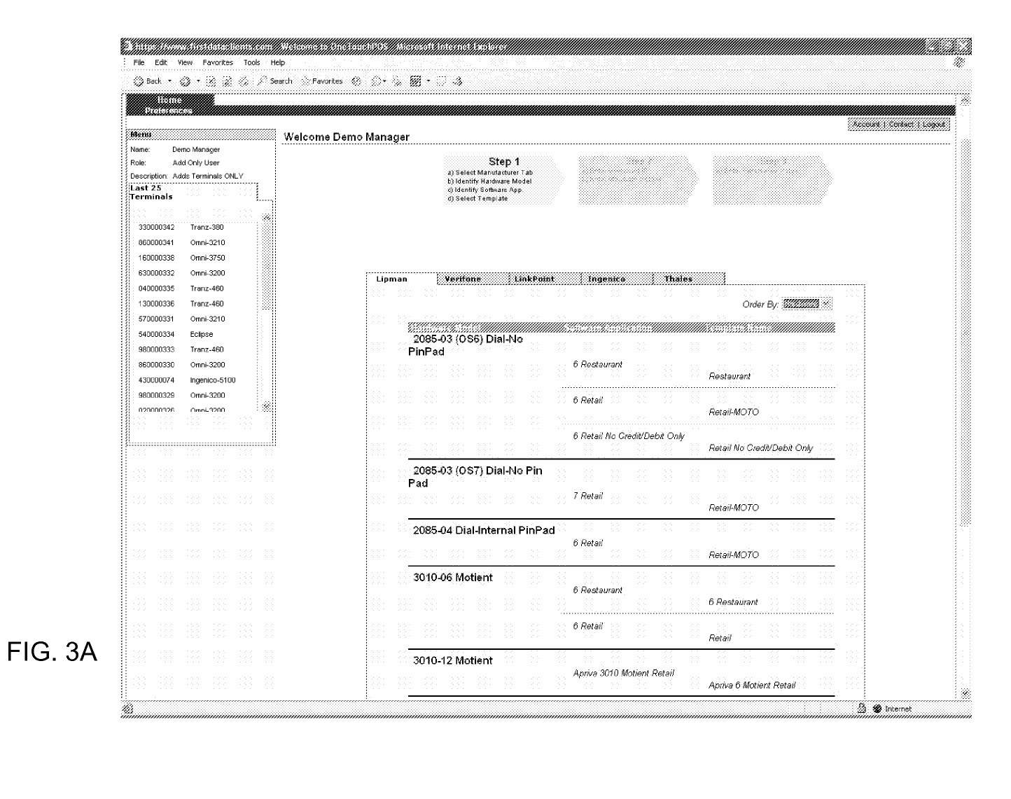

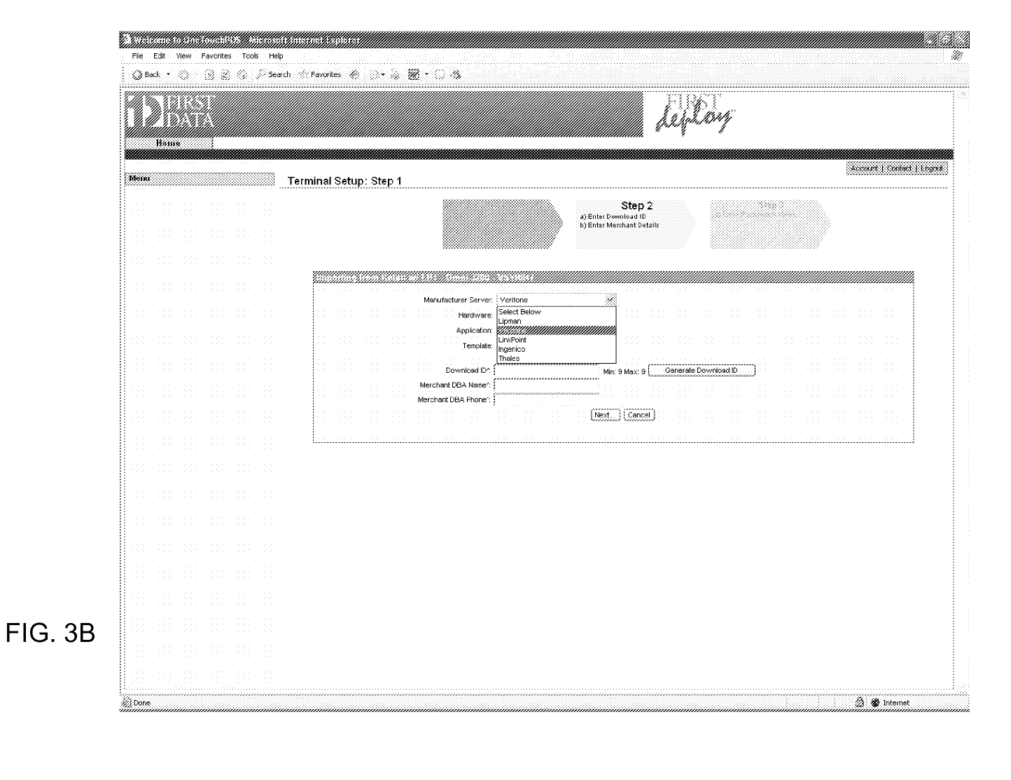

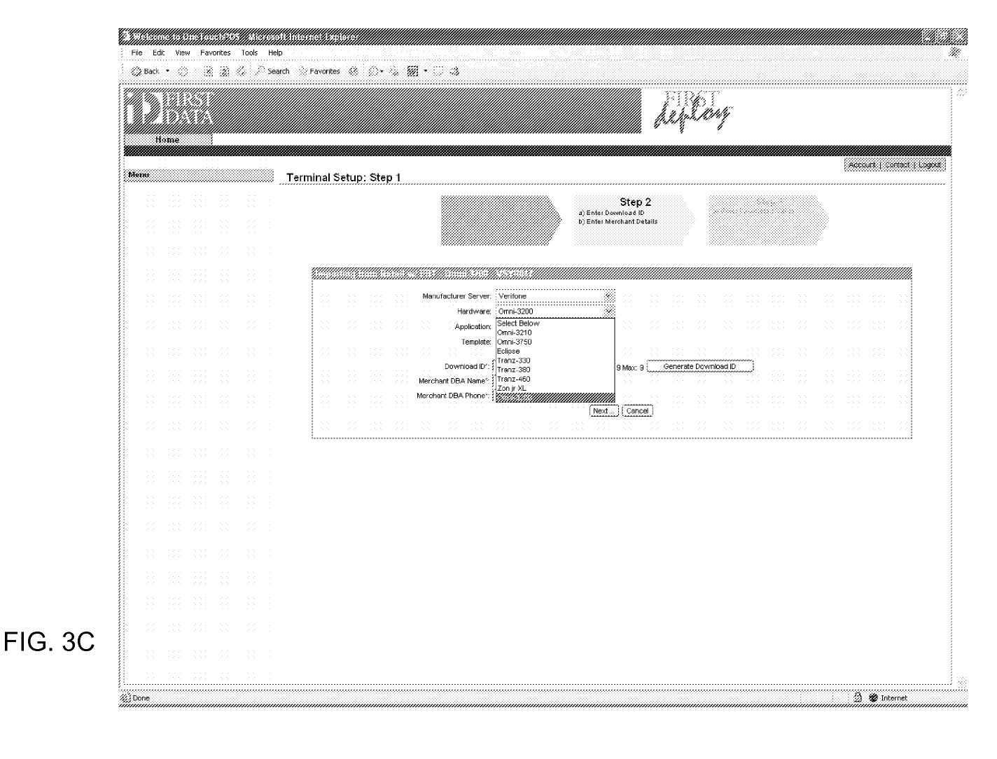

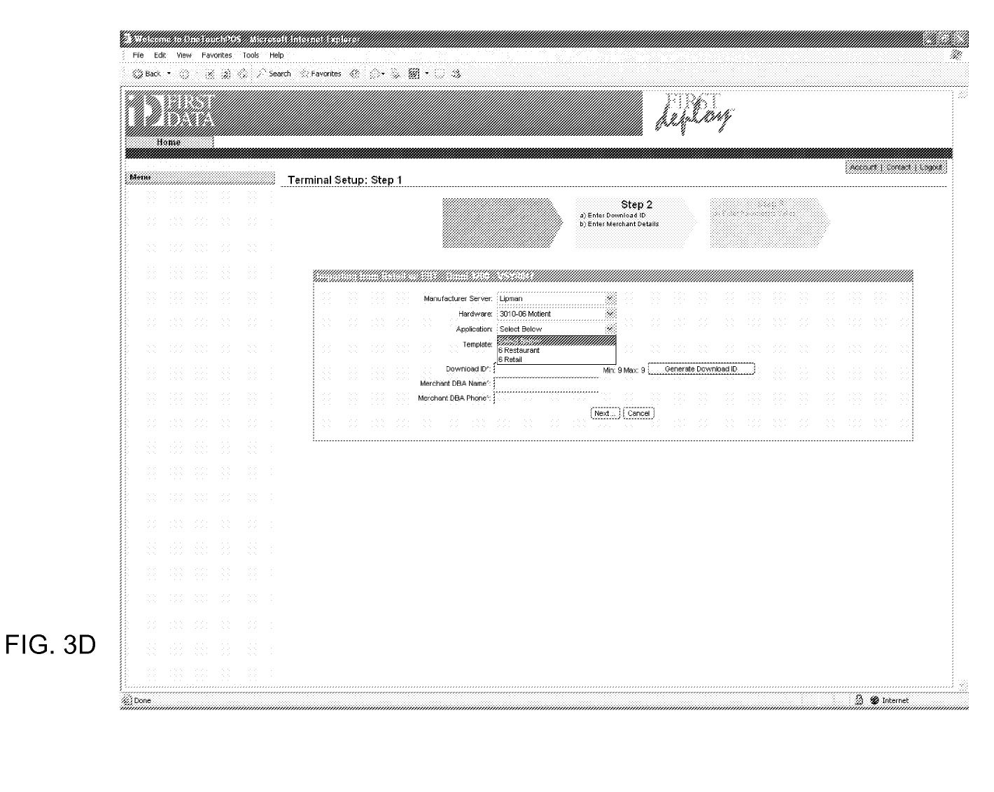

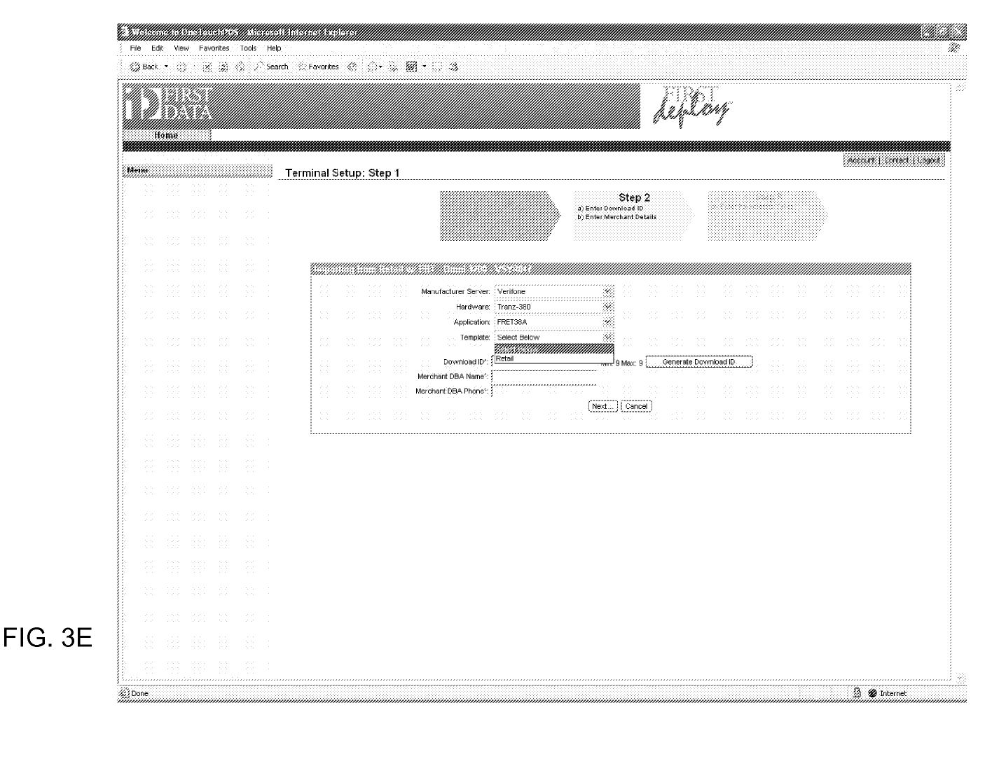

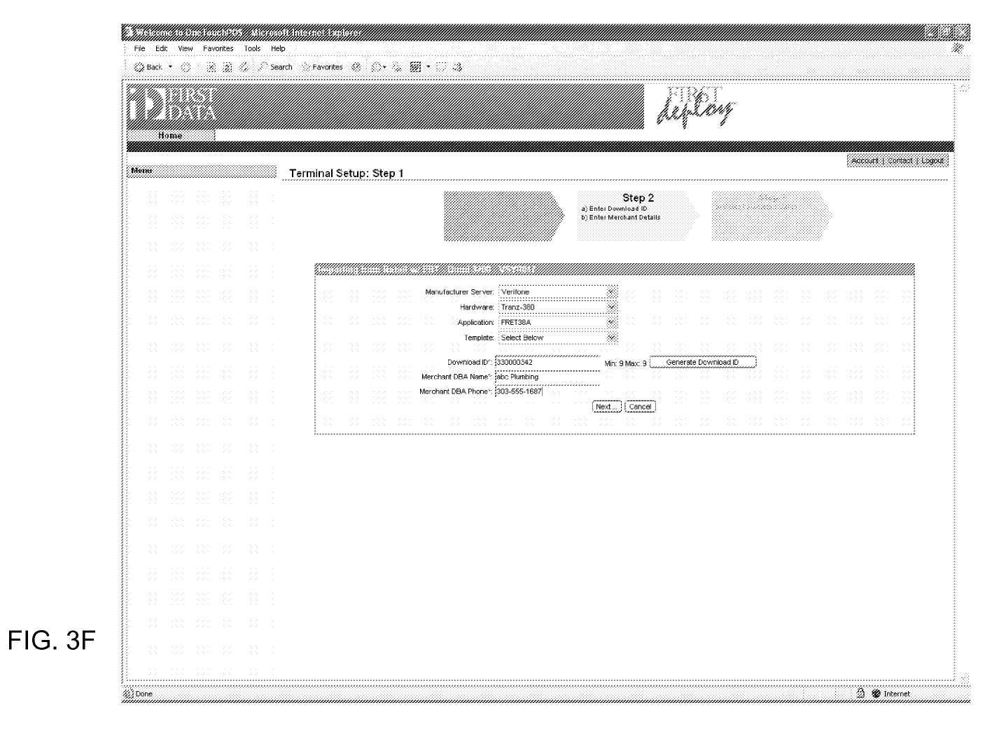

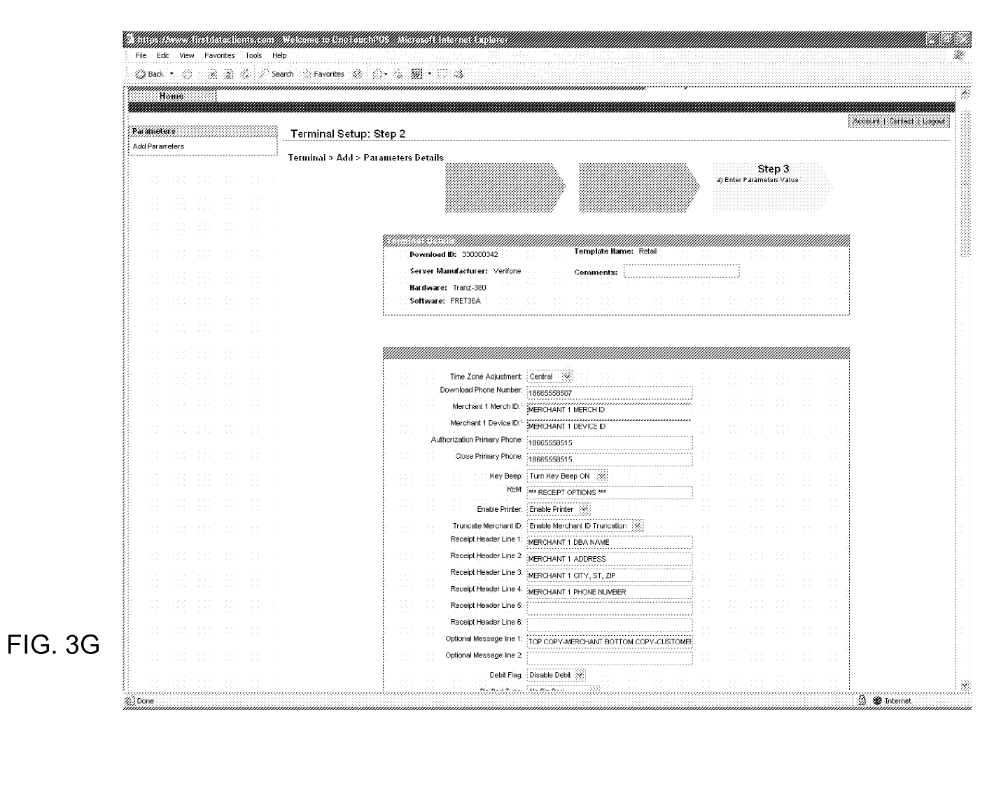

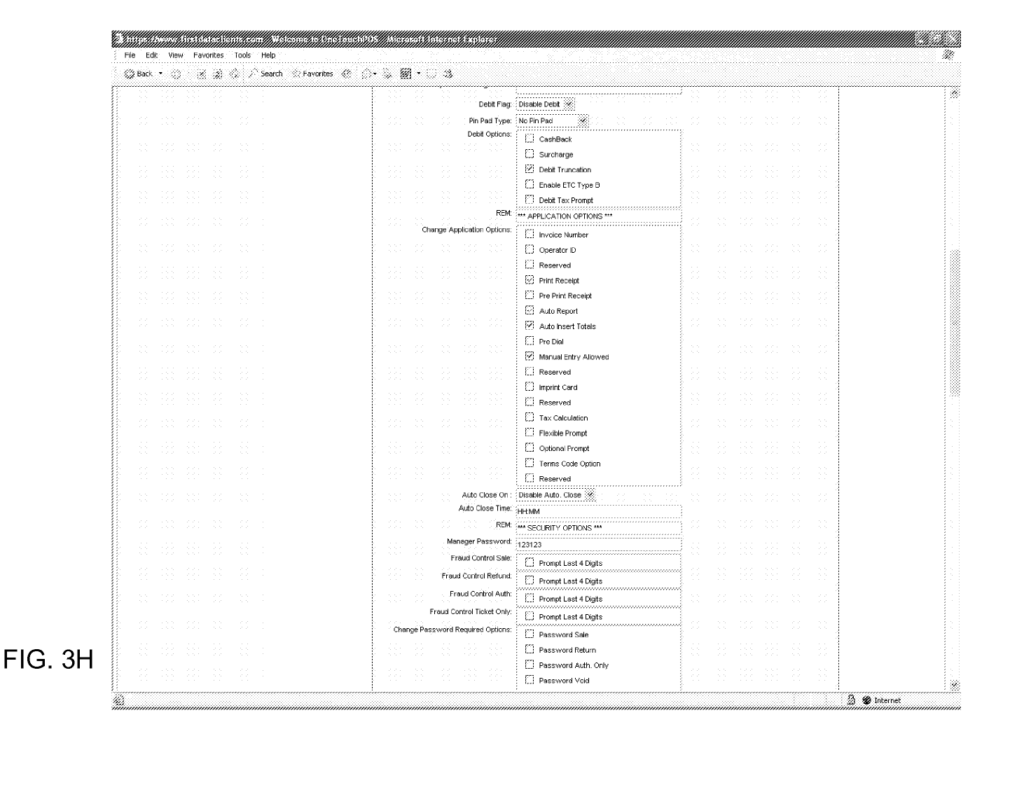

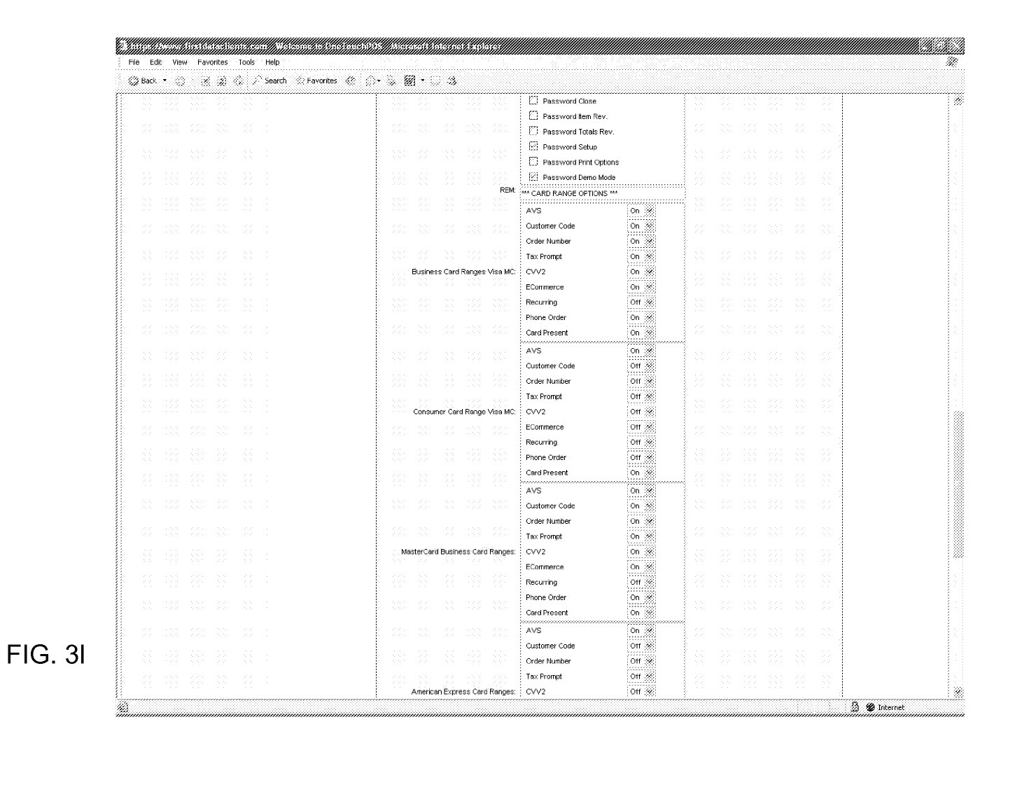

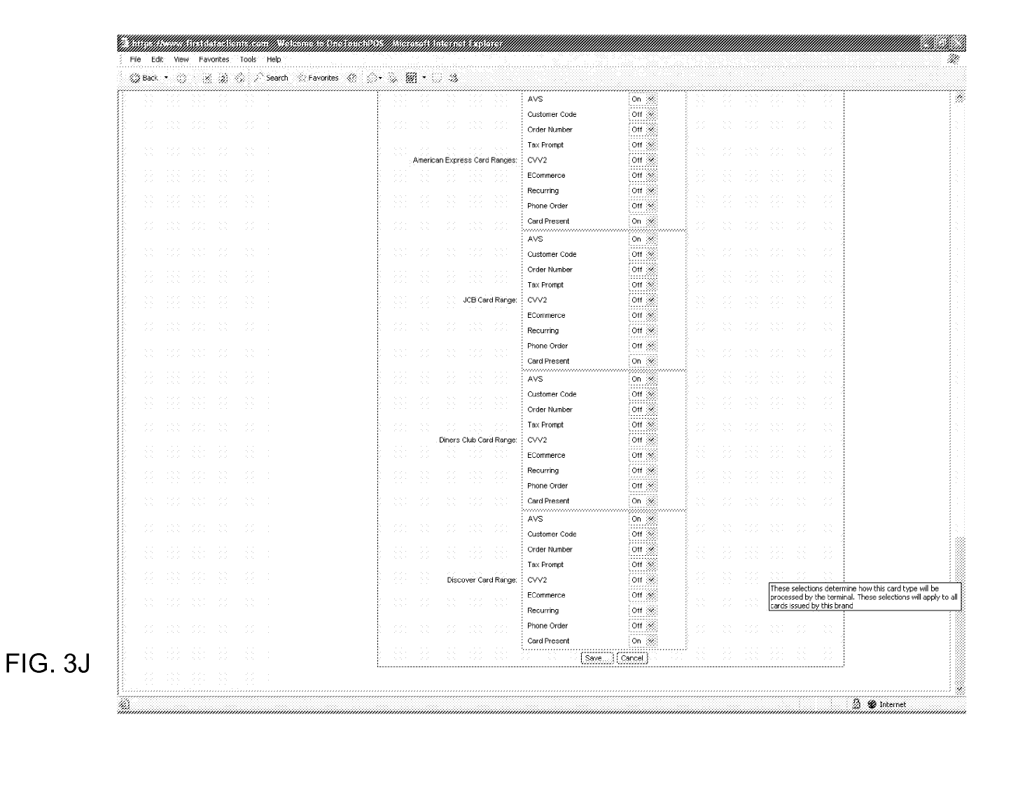

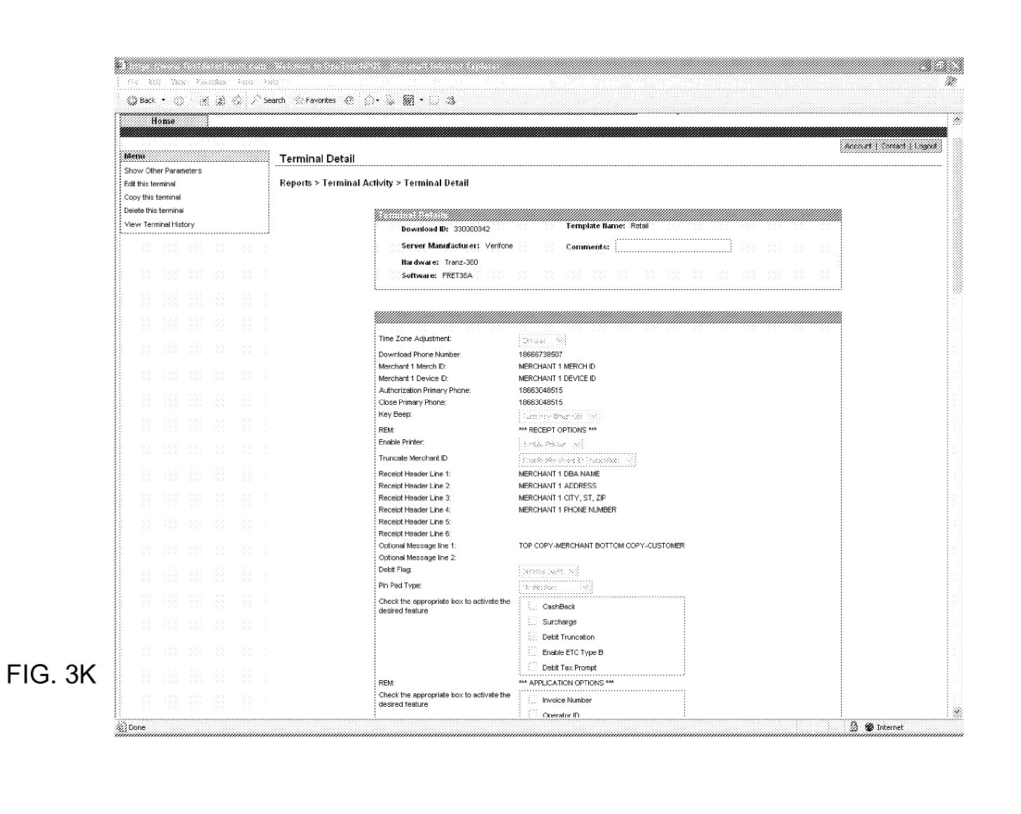

The method 200 begins at block 202 at which location a user accesses a POS device configuration web site. This may include providing appropriate login credentials, as is known in the art. As described previously, this may be accomplished using a user computer to access a server computer via the Internet. The server computer hosts the web site and causes POS device configuration display screens to be displayed on the user computer. FIGS. 3A-3K depict exemplary display screens and will be discussed in greater detail hereinafter.

At block 204 the user selects a POS device hardware manufacturer. At block 206, the user selects a POS device model. At block 208, the user selects a POS software application. And at block 210, the user selects a POS device configuration template. FIG. 3A illustrates an exemplary display screen for performing blocks 204, 206, 208, 210. In this exemplary display screen, the POS device hardware manufacturer is selected by selected an appropriate tab. Thereafter, the POS device model, software application, and template are displayed for the manufacturer, and the user merely scrolls through the list to find the appropriately-categorized template. Alternatively, as depicted in FIGS. 3B-3E, the user may pick the manufacturer, model, application, and template using drop down menus. As each selection is made, the content of a subsequent menu may change, so that the user is presented with only the valid selections in accordance with previous selections.

The method 200 continues at block 212 at which point the user enters or otherwise generates a download identifier to be used later to access the POS device configuration file. This may be accomplished by selecting the button 320 of FIG. 3F. FIG. 3F also depicts data entry fields into which the user enters a merchant's name and phone number at block 214. By selecting the “next” button of FIG. 3F, the interactive web site causes the entered information to be transmitted to the server computer and causes the display screen of FIG. 3G-3J to be rendered on the user computer.

At block 316, the user enters POS device configuration information into the display screen depicted in FIGS. 3G-3J. It is apparent to those skilled in the art that FIGS. 3G-3J depict views of the same display screen as the view of the display screen is scrolled within the browser window. Some of the data entry fields and features of the display screen depicted in FIGS. 3G-3J will be described hereinafter.

Once the user has entered the POS device configuration information, at block 218 the information is saved as a configuration file by selecting the “save” button of FIG. 3J. As described previously, the POS device configuration is saved to be accessed later by the POS device. In some embodiments, the file is uniquely related to the specific POS device to be configured. The user may review the saved information as depicted in the display screen of FIG. 3K.

At block 220 the POS device is interfaced to the server computer at block 220. The POS device is configured at block 222 by entering the download identifier into the POS device. The POS device sends the download identifier to the server computer, thereby accessing the POS device configuration file, which the server computer returns to the POS device. The POS device configuration file then configures the device according to the POS device configuration information entered by way of the interactive web site. In some embodiments, the server computer translates the POS configuration file into a language understandable by the specific POS device being configured.

In some embodiments, the POS device is shipped at block 224. This is the case if the device was configured prior to shipment. In other embodiments, the device is shipped first. A test transaction may be run at block 226 to confirm proper operation of the POS device. Assuming proper configuration, the POS device may thereafter be used to process transactions at block 228.

Attention is redirected to the display screen of FIGS. 3G-3J for a discussion of some of the data fields for collecting POS device configuration information. Those skilled in the art will appreciate that any of a variety of data fields may be included according to embodiments of the invention. FIG. 3G includes various merchant information, some of which may be included on receipts printed by the POS device being configured. FIG. 3H includes, among other things, data fields for configuring the POS device for various security and fraud detection operations. FIG. 3I includes data fields for configuring the POS device to accept or reject various types of presentation instruments. FIG. 3J includes additional data fields for configuring the POS device to accept or reject various types of presentation instruments. FIG. 3J also includes “Save” and “Cancel” buttons.

According to embodiments of the invention, the data fields may be drop down menus, fill-in-the-blank, pick lists, selection buttons, and/or the like. Also, the data fields and the selections they provide may be interdependent, the data selection of one being dependent on the user-provided content of another. The data fields also may be enabled to provide help by “hovering” a cursor over a data field. Many other examples are possible.

In some embodiments, the POS device configuration file creation process includes a selection whereby the user requests that a POS device matching the hardware manufacturer and model be shipped from a POS device deployment center. The selection may include an indicator that the user wants the POS device to be configured prior to shipment.

In some embodiments, the POS device configuration file creation process does not include rendering display screens on the display screen of the user's computer. The user may simply transmit a file to the server computer, which file includes the POS device configuration information. The file may be created on the user's computer using application specific software for any of a variety of POS devices. The file may be encoded in a format (e.g., XML) which the server computer receives and converts into the POS device configuration file. Many such examples are possible.

Having described several embodiments, it will be recognized by those of skill in the art that various modifications, alternative constructions, and equivalents may be used without departing from the spirit and scope of the invention. Additionally, a number of well known processes and elements have not been described in order to avoid unnecessarily obscuring the present invention. For example, those skilled in the art know how to arrange computers into a network and enable communication among the computers. Moreover, those skilled in the art will appreciate that the concepts discussed herein may be directed toward other types of “card not present” transactions, such as telephone purchases and the like. Accordingly, the above description should not be taken as limiting the scope of the invention, which is defined in the following claims.

What is claimed is:

1. A system for configuring a point-of-sale (POS) device, comprising:
a server computer programmed to interactively collect POS device configuration information from a remotely-located user computer and cause the POS device configuration information to be stored as a POS device configuration file, wherein the server computer is programmed to interactively collect the POS device configuration information from the user computer by rendering one or more display screens on the user computer, each of the one or more display screen being configured to collect at least a portion of the POS device configuration information;
a storage medium configured to store the POS device configuration file; and
an interface to the POS device, the interface being configured to transmit the POS device configuration file from the storage medium to the remotely-located POS device to thereby configure the POS device.

2. The system of claim 1, wherein the first network is the Internet and the second network is a Public Switched Telephone Network.

3. The system of claim 1, wherein the POS device configuration file is uniquely related to the POS device.

4. The system of claim 1, wherein a first portion of the POS device configuration information collected by a first display screen determines a second portion of the POS device configuration information collected by a second display screen.

5. The system of claim 1, wherein at least one of the one or more display screens includes a plurality of data collection fields configured to collect the POS device configuration information, wherein POS device configuration information collected by a first data collection field is determinative of selection options of POS device configuration information collected by a second data collection field.

6. The system of claim 5, wherein the selection options comprise a selection from the group consisting of:
pick lists; and
drop down menus.

7. The system of claim 1, wherein a data collection field associated with a first display screen comprises a selection mechanism to notify a POS deployment center to ship the POS device to a particular location.

8. A system for configuring a point-of-sale (POS) device, comprising:
a server computer programmed to receive data from a remotely-located user computer, wherein the data comprises POS device configuration information and wherein the server computer is further configured to cause the POS device configuration information to be stored as a POS device configuration file;
a storage medium configured to store the POS device configuration file; and
an interface to the POS device, the interface being configured to transmit the POS device configuration file from the storage medium to the remotely-located POS device to thereby configure the POS device.

9. The system of claim 8, wherein the data are comprised by an XML file.

10. The system of claim 8, wherein the first network is the Internet and the second network is a Public Switched Telephone Network.

11. A method of configuring a point-of-sale (POS) device, comprising:
at a host computer system, receiving a file creation request from a remotely-located user computer to create a POS device configuration file;
in response to the file creation request, rendering one or more display screens on a display of the user computer, wherein the display screens are programmed to interactively collect POS device configuration information from the remotely-located user computer;
storing the POS device configuration information as a POS device configuration file;
transmitting a download identifier related to the POS device configuration file to the remotely-located user computer;
thereafter, receiving a configuration request at the host computer system from the POS device, wherein the configuration request includes the download identifier; and
in response to the configuration request, sending the POD device configuration file to thereby program the POS device.

12. The method of claim 11, wherein receiving the file creation request comprises receiving the file creation request via the Internet.

13. The method of claim 11, wherein receiving the configuration request comprises receiving the configuration request via a Public Switched Telephone Network.

14. The method of claim 11, wherein the POS device configuration file is uniquely related to the POS device.

15. The method of claim 11, wherein rendering one or more display screens on a display of the user computer comprises:
rendering a first display screen on the display of the user;
receiving a first portion of the POS device configuration information via the first display screen; and
using the first portion of the POS device configuration information to determine a second portion of the POS device configuration information collected by a second display screen.

16. The method of claim 11, wherein at least one of the one or more display screens includes a plurality of data collection fields configured to collect the POS device configuration information, the method further comprising:
using POS device configuration information collected by a first data collection field to determine selection options of POS device configuration information collected by a second data collection field.

17. The method of claim 16, wherein the selection options comprise a selection from the group consisting of:
pick lists; and
drop down menus.

18. The method of claim 11, wherein a data collection field associated with a first display screen comprises a selection mechanism to notify a POS deployment center to ship the POS device to a particular location, the method further comprising:
receiving a selection via the selection mechanism to notify the POS deployment center;
notifying the POS deployment center in response to receiving the selection; and
shipping the POS from the POS deployment center.

19. A method of configuring a point-of-sale (POS) device, comprising:
at a host computer system, receiving a file creation request from a remotely-located user computer to create a POS device configuration file, wherein the file creation request includes POS device configuration information;
storing the POS device configuration information as a POS device configuration file;
transmitting a download identifier related to the POS device configuration file to the remotely-located user computer;
thereafter, receiving a configuration request at the host computer system from the POS device, wherein the configuration request includes the download identifier; and
in response to the configuration request, sending the POS device configuration file to thereby program the POS device.

20. The method of claim 19, wherein the POS device configuration file is comprised by an XML file.
